(19) United States
(12) Patent Application Publication
(10) Pub. No.: US 2005/0235260 A1
(43) Pub. Date: Oct. 20, 2005

(54) User interface application development device and development method

(75) Inventors: Takahide Matsutsuka, Kawasaki (JP); Masahiko Kamo, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/146,355

(22) Filed: Jun. 7, 2005

Related U.S. Application Data
(63) Continuation of application No. PCT/JP03/06536, filed on May 26, 2003.

(51) Int. Cl. G06F 9/44

(52) U.S. Cl. 717/114

(57) ABSTRACT

An application program having a user interface is automatically generated to improve the program development efficiency and maintainability. An application development device includes a specification data reading unit for reading in specification data, which corresponds to a screen transition diagram where a screen and a process are alternately described, whereby the screen is related to the display input data item and the display input data item is related to the screen layout, and a program generation unit for automatically creating an application program by using the specification data.

### CROSS-REFERENCE TO RELATED APPLICATION

This application is a continuation of International Application No. PCT/JP2003/06536, which was filed on May 26, 2003.

### BACKGROUND OF THE INVENTION

1. Field of the Invention

The present invention relates to development and execution system of a program, and more specifically to a user interface application development device and development method, which enables automatic generation of an application program having a user interface and improvement of a program development efficiency and maintainability.

2. Description of the Related Art

As a recent software design method, a method using an object-oriented technology is widely employed. In particular, a platform-independent language called UML (Unified Modeling Language) and object-oriented languages, such as a Web application development system combined with Java, attract public attention.

As such software development method, a method, which can automatically generate the program or components thereof, is desirable. The following are conventional arts of such an automatic generation of programs.

Patent Document 1:

Japanese unexamined patent publication bulletin No. 06-230949 “Automatic Program Generating Device”
   Patent Document 2:
Japanese unexamined patent publication bulletin No. 11-237982 “Software Component Development Supporting Device”
   Patent Document 3:
Japanese unexamined patent publication bulletin No. 2000-339149 “State Transition Model Preparation Method and its Device”
   Patent Document 4:
Japanese unexamined patent publication bulletin No. 2000-116911 “Automatic Generation Device for Object-Oriented Program”

In Patent Document 1, it is described that an automatic program generating device, which can reuse the specifications of an unchanged unit in the change of a component unit of a controlled system, thereby improving software production efficiency, and also can perform the compact and clear description of specifications for a large number of units.

Patent Document 2 discloses a reusable component development supporting technology for development of reusable components in an object-orientated software, utilizing information concerning the fixed/variable parts of a specification obtained by analyzing a requested specification common for applications in a certain subject area.

In Patent Document 3, technologies to shorten a time necessary for the state extraction, the extraction of an input event, and the extraction of an action, and the extraction of an output event in generating a state transition model are described.

Patent Document 4 discloses an automatic generation device of a program, which can improve the work efficiency of the software development by automatically generating the program code of the static part along with automatically generating the program code of the dynamic part in development of an object-oriented program.

However, in Patent Document 1, the relation between units has to be described by a state transition model. Relation among a client side screen, display data item and screen layout in a user interface application, for example, has to be described by the state transition model, and the problem is that development takes time and effort.

In Patent Document 2, the object-oriented software component is developed by converting the analysis model of a requested specification into design information, however, depending on a definition of a design model, there is difficulty in automatic conversion into a Web application program, for example.

In Patent Document 3, because a message sequence chart must be described in addition to the state transition chart, there is a problem that it takes time and effort to automatically generate a program.

In Patent Document 4, after the extraction of the dynamic part definition and establishment of a state machine tree, generation of a program code requires to be combined with the static part, and the problem is also that it needs time and effort to develop a final program product.

### SUMMARY OF THE INVENTION

It is an object of the present invention to provide a development device and a development method, which facilitate automatic generation of a user interface application program, by contriving ways to create specification data for program development in a user interface application development.

The user interface application development device of the present invention comprises specification data reading means and program generation means.

The specification data reading means reads in the specification data for program development which is equivalent to a screen transition diagram with a format alternately describing a screen and a process, one screen and one or more processes being alternately described in the format, where a screen is related to a display input data item and a display input data item is related to a screen layout, and the program generation means automatically generates a user interface application program using the specification data.

The user interface application development device of the present invention also comprises specification data reading means and process execution means.

The specification data reading means reads in the specification data for program development as described above, and the process execution means interprets the read-in specification data, and in response to the interpretation result, executes user interface application process.

The user interface application development device of the present invention further comprises specification data reading means and program generation means.

The specification data reading means reads the specification data for program development which is equivalent to a screen transition diagram with a format describing transition between a plurality of screens in which corresponding processes are predetermined, where a screen is related to a display input data item and a display input data item is related to a screen layout, and the program generation means, using the specification data, automatically generates the user interface application program in which the program is recursively developed with the specification and the content of the relation of the two being changed.

As described above, according to the present invention, using a specification data, equivalent to a screen transition diagram with a format contrived as a specification data for program development, that is, a format where a screen and a program are alternately described, automatic generation of a user interface application program or execution of application process is carried out.

### BRIEF DESCRIPTION OF THE DRAWINGS

FIG. 1 is a principle configuration block diagram of a user interface application development device of the present invention;

FIG. 2 describes an entire view of definition for the user interface application development;

FIG. 3 shows an example of a screen transition definition;

FIG. 4 shows an example of a screen layout definition in the screen transition definition;

FIG. 5 is an example showing a business flow definition;

FIG. 6 describes an example of a screen item definition;

FIG. 7 is an explanatory diagram of a minimum required screen transition definition when omitting some part of the definition;

FIG. 8 is an explanatory diagram of an example of screen transition when the omission is carried out;

FIG. 9 is an explanatory diagram of automatic generation of the user interface application;

FIG. 10 is a basic flowchart of a program generation process using an automatic generation tool;

FIG. 11 explains a structure of the automatically generated application;

FIG. 12 explains operation form of carrying out the process and interpreting definition body;

FIG. 13 is an explanatory diagram of an external specification document generation by a specification generation tool;

FIG. 14 is a basic flowchart of the external specification generation process;

FIG. 15 is an explanatory diagram of detection of instruction execution place etc. by a debug tool;

FIG. 16 is an explanatory diagram of test data generation and test execution operation;

FIG. 17 is an explanatory diagram of affected range detection operation after definition body modification; and

FIG. 18 is an explanatory diagram of recursive development of the user interface application.

### DESCRIPTION OF THE PREFERRED EMBODIMENTS

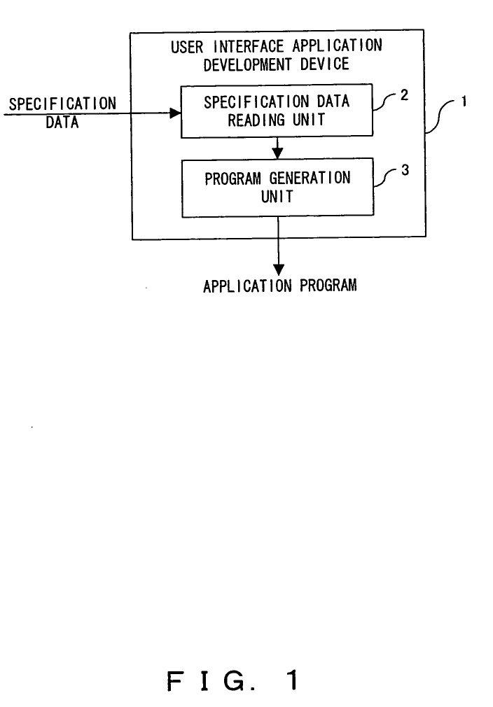

FIG. 1 is a block diagram of principle configuration of the user interface application development device of the present invention. In FIG. 1, a development device 1 comprises a specification data-reading unit 2 and a program generation unit 3.

The specification data-reading unit 2 is for reading in specification data for program development, written in UML for example, and the specification data is equivalent to a screen transition diagram with a form in which the screen and process are alternately described, where a screen is related to a display input data item and a display input data item is related to a screen layout. The program generation means 3, using the specification data and a business flow definition diagram, for example, automatically generates platform-dependent formed user interface application program utilizing automatic generation tool for Java Server Pages (JSP)/Servlets, for example.

Here, the JSP/Servlets carries out Web server processing by Java language, and sends HTML file to a Web browser.

The user interface application development device 1 can further comprise a constraint condition check unit not shown in the figures. The constraint condition check unit checks constraint conditions established in response to display input data items. When the conditions are not satisfied, it prohibits transition from a screen to a process on the screen transition diagram. In such a case, information to designate checkpoints of constraint conditions in response to the constraint conditions is provided, and therefore it is possible that the constraint condition check unit can check in accordance with the designation.

The user interface application development device 1 can further comprise an application verification unit also not shown in figures. The application verification unit creates test data in response to the display input data items, and carries out program verification by inputting the test data in the generated program. In so doing, the application verification unit stores verification results of programs so that, when specification data for program development etc. is modified, the unit can detect the affected range of application modification by comparing the verification result with that of a modified program, using the same test data.

Moreover, the user interface application development device 1 can further comprise a screen generation unit not shown in figures. The screen generation unit automatically carries out screen generation according to rules for pre-established screen layout in response to the display input data items. The user interface application development device 1 can further comprise an external specification generation unit. The external specification generation unit filters information of internal specification representing the user interface application model, and automatically generates external specification document with additional information representing the external specification. Incidentally, the internal specification corresponds to specification data for program development.

The user interface application development unit can further comprise a debug unit. The debug unit carries out debug of the program generated by the program generation unit. The program generation unit embeds instructions to issue events in the program during automatic generation of the program, and the debug unit receives the events when debugging and can recognize the embedded point of event issue instruction as program execution point. The program generation unit sets information indicating breakpoints as a process responding to the event issue, and when the debug unit detects the information, the section corresponding to the breakpoints can be emphasized on the screen. Moreover, by embedding data handled in the embedded place of the event issue instruction in the event, and by corresponding the data to a class in a diagram representing the specification data with an identifier, it is possible to detect data types and values when the debug unit receives the event. Here, the debug unit can store the detected data value so that the affected range of application modification can be detected by comparing the data with that at the same section in debugging after the application is modified.

The user interface application development device of the present invention can comprise a processing unit instead of the program generation unit 3 in FIG. 1. The processing unit interprets the specification data taken in by the specification data-reading unit 2, and, depending on the interpretation result, executes user interface application process.

The user interface application development device 1 comprises a specification data-reading unit 2 and a program generation unit 3 as in FIG. 1. The specification data-reading unit 2 reads in the program development specification data which is equivalent to screen transition diagram with a form in which transitions between a plurality of screens are described where the specified corresponding process is determined for each, and a screen is related to a display input data item and a display input data item is related to a screen layout in the program. The program generation unit 3 automatically generates the user interface application program using the specification data. And by repeating the operations of the specification data-reading unit 2 and the program generation unit 3 with the above content of the corresponding processes changing, it is possible to perform recursive development of a program, which repeats phases of analysis, design, implement, and verification, for example.

Next, as a development method of a user interface application, a method is used, wherein a specification data for program development is read, which is equivalent to screen transition diagram of a from in which the screen and process are alternately described, and a screen is related to a display input data items and a display input item is related to a screen layout in the program, and the user interface application program using the specification data is automatically generated. And a program for realizing this method is also used.

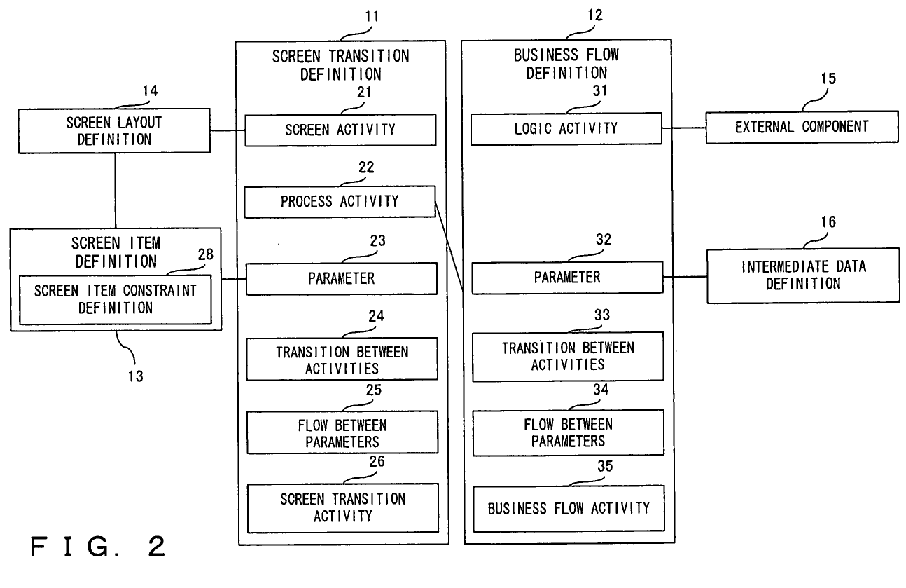

FIG. 2 is an entire view of definition for the user interface application development in the present embodiment. In FIG. 2, the definition consists of a screen transition definition 11, a business flow definition 12, a screen item definition 13, and a screen layout definition 14, and a business flow definition 12 is related to an external component 15 and an intermediate data definition 16.

The screen transition definition 11 represents the state of screen transition by an initial state and a final state not shown in FIG. 2, screen activity 21, process activity 22, a parameter 23, transition between activities 24, flow between parameters 25 and screen transition activity 26 indicating partial screen transition within the whole screen transition definition 11.

The initial state and the final state define the position where screen transition starts and the position where screen transition terminates, respectively. The screen activity 21 comprises a reference process of the screen layout definition 14, input parameter and output parameter, and carries out screen display utilizing the screen layout based on the input parameter. For example, data input from client (user) side is assigned to the output parameter.

The process activity 22 comprises reference process of the business flow definition 12, an input parameter and an output parameter, requests process execution by passing the input parameter to business flow, and upon termination of the process, assigns data output from business flow to the output parameter.

The parameter 23 indicates a data object, and defined by the screen item definition 13. In the relating flow between parameters 25, it is defined that the flow is from the output parameter to the input parameter, and therefore the contents of the output parameter is assigned to the input parameter as explained later.

The transition between activities 24 hypothetically has the following rules.

(1) From the initial state, transition is allowed only to the process activity 22.

(2) From the screen activity 21, transition is allowed only to the process activity 22. In this transition, an action guard can be added as a condition. For the conditions as an action guard, whether or not the guard condition is satisfied can be recognized by allocating a button pressed in the client side in sending events from the client side to the server side. When transition with “Retry Error” guard from the screen activity 21, as explained later, is written, the target of the retry is the same screen activity.

(3) From the process activity 22, transition is allowed to any of the screen activity 21, the process activity 22 or the final state.

The screen transition activity 26 refers to a part of the other screen transition diagram in the screen transition definition 11, and comprises an input parameter and an output parameter. The content input in the input parameter is going to be a reference destination, that is an input parameter of screen transition diagram as another diagram. When the process in the reference destination screen transition diagram is terminated, the output parameter of the process is assigned to the output parameter of the screen transition activity 26.

The screen item definition 13 defines items for screen display. The items consists of a name and a type, and the type can be a character string, a integer number, a real number, date, enumeration, and combination type. It is also possible to define the additional types.

For the items defined by the screen item definition 13, the screen item constraint definition 28 is defined if needed. It is possible to set the following constraint items for each type of the items. The constraints are not limited to those presented herein, but they can be defined outside if more constraints are needed.

It is also possible to designate whether checking of the conditions written as constraints is to be performed on the screen, that is, in the client side, or in the server side. By so doing, in automatic generation of program as an application, which part is to output codes for executing process is determined.

There are minimum digit limit, maximum digit limit, and character type limit and compulsory input as constraints to the character string. The compulsory input determines whether the input of the character string is inevitable or not.

For the integer number and the real number, there are constraints of minimum digit limit, maximum digit limit, and compulsory input etc., and constraints to date are whether it is present or not, compulsory input and so forth.

For enumeration, constraint contents of single selection limit, which is the limit such that one alone is definitely selected, and compulsory input are applied, and for the combined type, constraint content of each item involved is applied.

Next, in the business flow definition 12 the initial state and the final state not shown in figures, the logic activity 31, the determination and parameter 32 not shown in figures, the transition between activities 33, the flow between parameters 34, and the business flow activity 35 are defined and details of the process are represented.

The initial state and the final state define positions where the business flow starts and terminates, respectively. The logic activity 31 is basically equivalent to process to refer to the external component 15, and comprises an input parameter and an output parameter. The input parameter is provided to the external component 15 and execution of the process is requested, and upon finish of the process, output of the external component 15 is assigned to the output parameter.

The determination, not shown in figures, comprises an input parameter and branching is carried out depending on the parameter contents. The parameter 32 indicates a data object and is defined by the screen item definition 13 or the intermediate data definition 16.

The transition between activities 33 has rules as the transition between activities 24 in the screen transition definition 11 does. The rules are:

(1) From the initial state, it is possible to transit for either of the logic activity 31, condition determination, the business flow activity 35 or the final state. From the logic activity 31, the the same transition as the one from the initial state can be performed; and

(2) From the business flow activity 35, which is the activity referring to the other business flow, transition to either of the logic activity, condition determination, the business flow activity or the final state is possible.

The flow between parameters 34 defines the input parameter from the output parameter as it does in the business flow definition 12, and therefore the content of the output parameter is assigned to the input parameter.

The external component 15 is referred from the logic activity 31 inside the business flow definition 12, and a program code is written corresponding to a necessary process. In the intermediate data definition 16, item definition of intermediate data, used inside the business flow definition 12, is carried out.

To all model information explained above, comment information can be added as an additional item. The comment information can be written in atypical format such as natural language, and describing and referring to the information can be achieved at an arbitrary step in development.

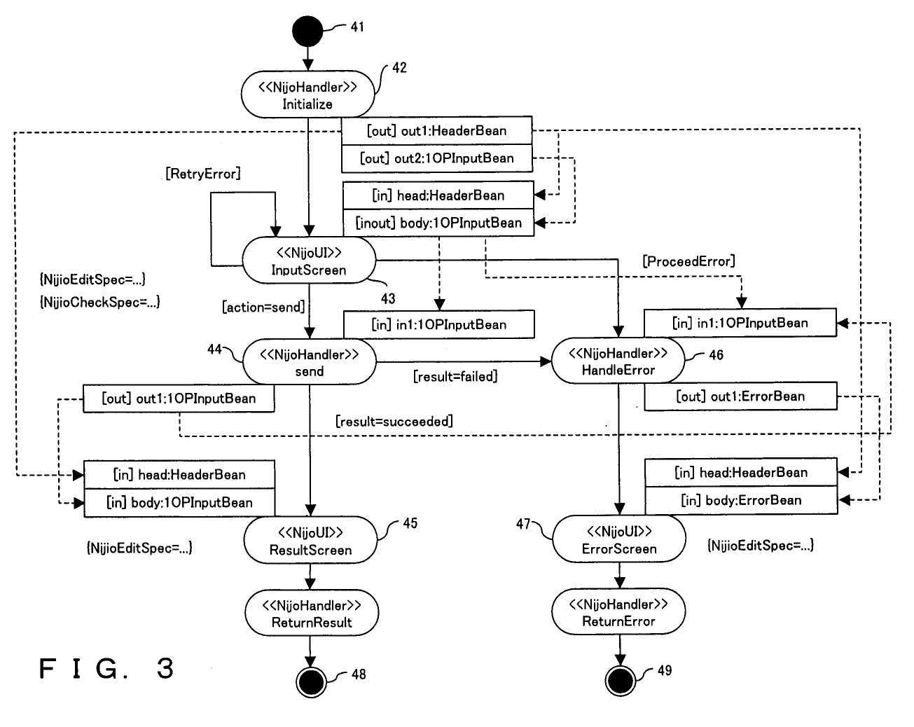

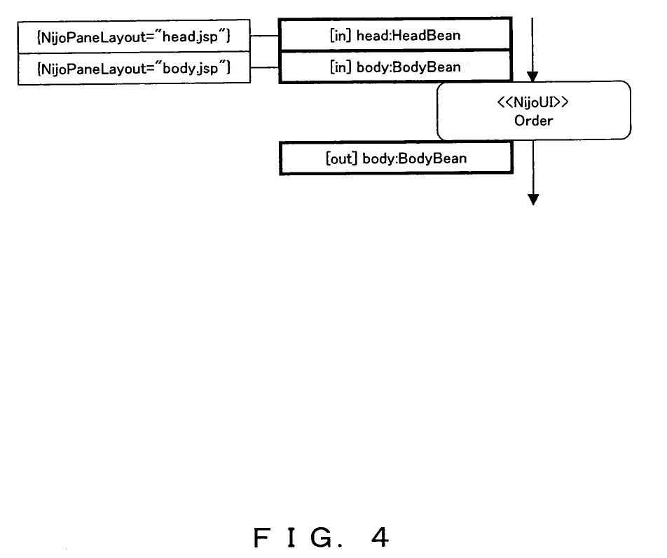

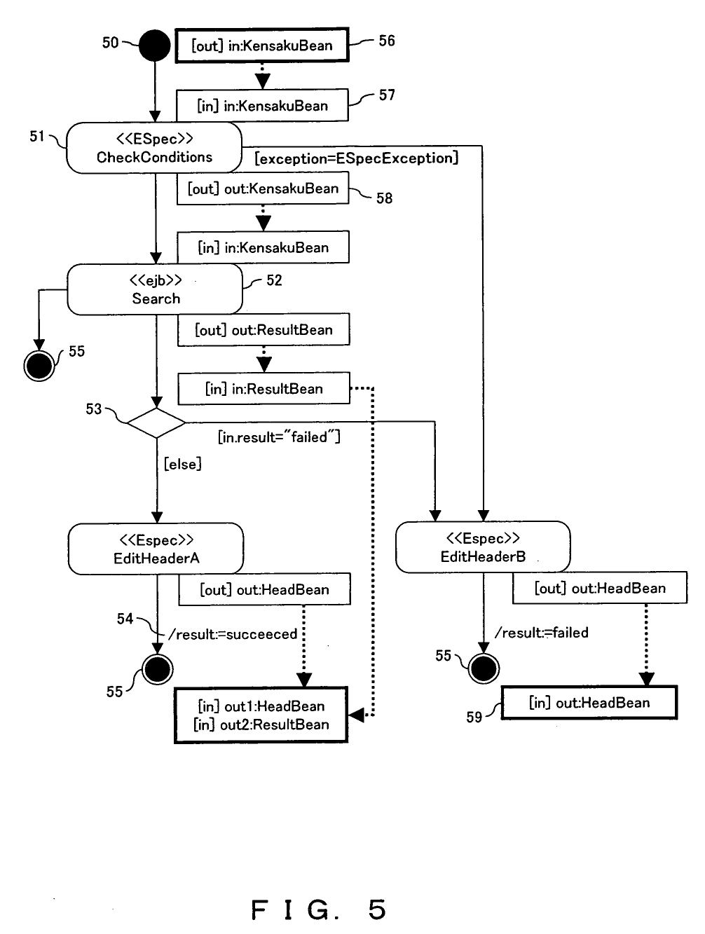

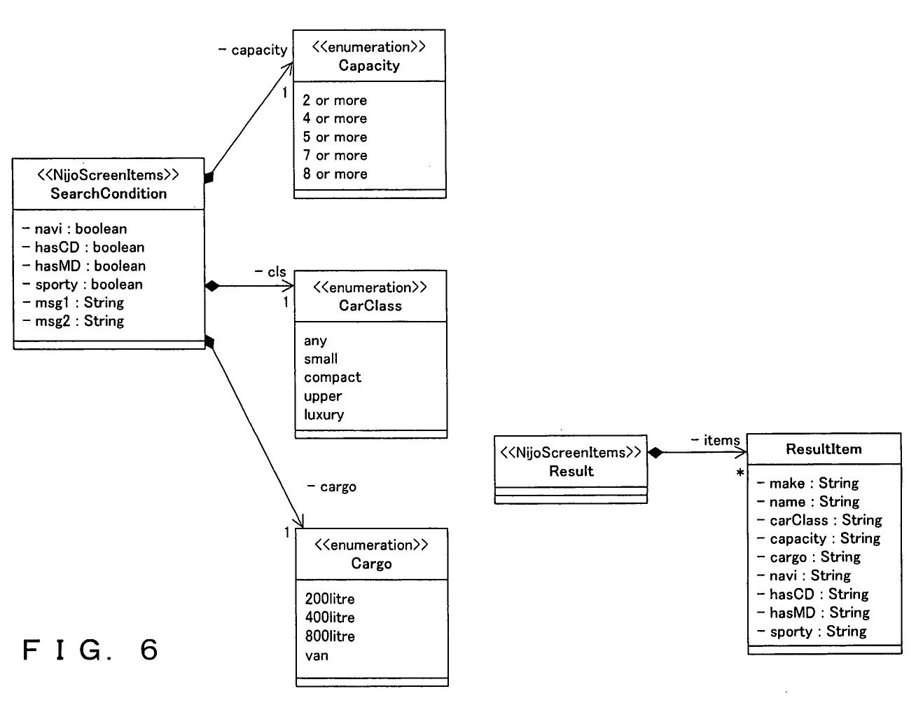

FIG. 3 and FIG. 4 are explanatory diagrams of examples of screen transition definition, FIG. 5 is that of business flow definition, and FIG. 6 is that of screen item definition. In the present embodiment, an explanation is provided on the basis of a method utilizing an activity diagram as description format of specification data, however it is also possible to utilize table format, for example, as description format.

In the screen transition definition shown in FIG. 3, a screen transition can be defined between the initial state 41 and the final state 48 or 49. In this screen transition, basically, the screen transition is defined in a form that the transition is performed alternately between process activity and screen activity. First, from the initial state 41, transition to process activity 42 of “Initialize” is described, and next, transition to the screen activity 43 of “Input Screen” is performed.

In the transition from the process activity 42 to the screen activity 43, a flow between parameters, indicating assignment of two output parameters of the process activity 42 to two input parameters of the screen activity 43, is indicated in broken lines. Also, it is indicated that transition target with “Retry Error” guard to the screen activity 43 is the same screen activity 43.

As transition from the process activity 43 of “Input Screen”, depending on condition determination whether “action=send” or “Proceed Error”, transition to either of the process activity 44 of “Send” or the process activity 46 of “Handle Error” is carried out.

Moreover, from the process activity 44 of “Send”, depending on content of “Result”, transition to either of the screen activity 45 of “Result Screen” or the process activity 46 of “Handle Error” is to be performed, and from the process activity 46 of “Handle Error” transition to the screen activity 47 of “Error screen” is performed.

FIG. 4 is an explanatory diagram of association of the input data item with the screen layout on the diagram of screen transition definition. FIG. 4 shows that two input data items of “order” activity are defined as layouts of “head.jsp” and “body.jsp”, respectively.

FIG. 5 is an example of business flow definition diagram. FIG. 5 supports a car rental business, for example. In FIG. 5, it is shown that transition from initial state 50 to “Check Conditions” logic activity 51 is first carried out, and in response to the transition, flow between parameters from the initial state output parameter 56 to input parameter 57 of the logic activity 51, or assignment, is performed. Also in the transition from the logic activity 51 to “Search” logic activity 52, an output parameter 58 of the logic activity 51 is assigned to an input parameter of the logic activity 52.

According to determination result of the condition determination 53, when a result 54 is succeeded, the result 54 is provided to termination state 55 through “Edit Header A” logic activity. When the result is failed, or when an exception occurs in the logic activity 51, transition to the termination state 55 is carried out through “Edit Header B” logic activity. In either case, termination state input parameter 59 is provided.

FIG. 6 is an example of screen item definition. The intermediate data items are also defined in the same format. The left of FIG. 6 shows an example of class diagram indicating composition aggregation and the right of FIG. 6 is a class diagram showing an example of combined type. In these class diagrams, for example, an operation (method) for an object “Search Condition” is omitted.

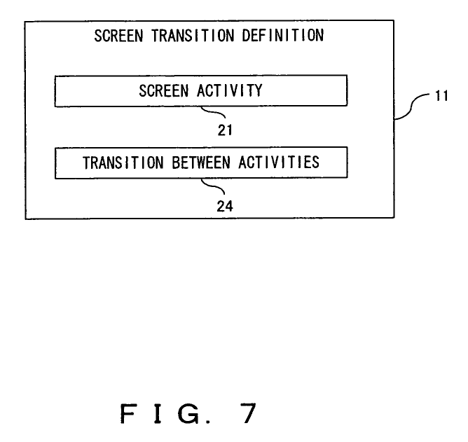

The definition explained in FIG. 2 indicates the entire picture, and it is possible to describe the definition with a part omitted in the early stages of the user interface application development, for example. FIG. 7 explains minimum required screen transition definition when such omission is carried out. In FIG. 7, the screen transition definition 11 is represented by only the screen activity 21 and transition between activities 24.

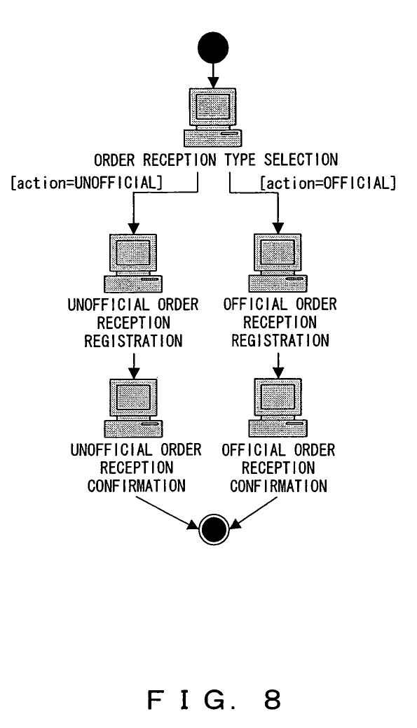

FIG. 8 is an explanatory diagram of an example of screen transition when such omission is to be performed. In FIG. 8, after transition to order receiving type selection screen activity from the initial state, in response to whether the action was official or unofficial, it is determined that transition to the final state is carried out whether after transition to official order reception registration and official order reception confirmation screen or after transition to unofficial order reception registration and unofficial order reception confirmation screen is processed.

When omitting definition as in FIG. 7, the content omitted is generated following the rules below. For the screen layout definition 14, only a button for event occurrence is present to specify action from the client side, and when the screen item definition 13 has been generated, the corresponding screen layout is automatically generated according to the pre-determined rules.

For the process activity 22 inside the screen transition definition 11, it is assumed that there is activity, which does not do anything, and for the screen transition activity 26, or for reference to the other screen transition diagram, such process is not used. It is also assumed that there is no data for the parameter 23, and because the parameter does not exist, flow for the flow between parameters 25 does not exist either.

For the screen item definition 13, generally, it is assumed that there is no display input item, and therefore there is nothing in the screen item constraint definition 28.

For the business flow definition 12, it is assumed that there is no business flow, and because the business flow does not exist, intermediate data to be used does not exist for the intermediate data definition 16. By supplying various definitions from such a minimum required state, the definition can be close to be faultless little by little, and the user interface application development can be proceeded step by step.

By completion of the definition for the user interface application development explained in FIG. 2, or by applying a platform-dependent automatic generation tool to the definition body equivalent to uncompleted definition in omitted format explained in FIG. 7, a Web application or a client application can be generated as a user interface application.

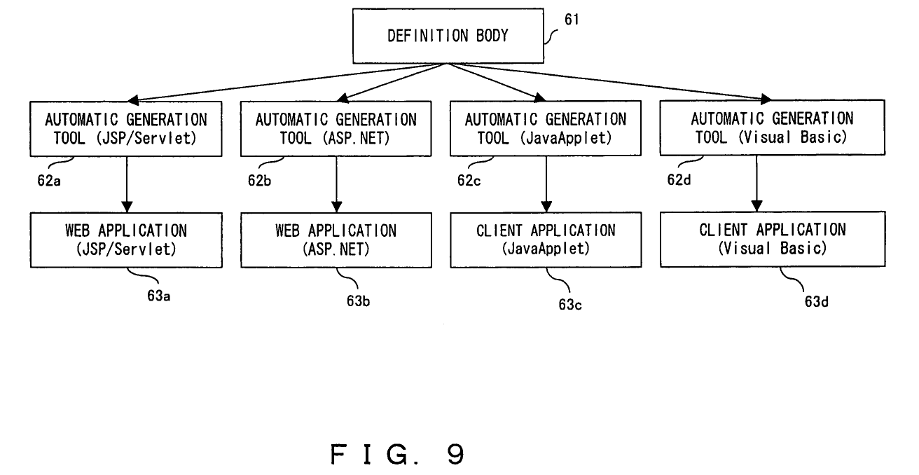

FIG. 9 is an explanatory diagram of such automatic generation. In FIG. 9, by using an automatic generation tool 62a for JSP/Servlet, for example, as described above to definition body 61, a Web application 63a for JSP/Servlet can be generated.

Similarly, by using an automatic generation tool 62b for Active server Pages (ASP) NET, which is as one of the systems for creating pages on a Web server, a Web application 63b can be generated.

Additionally, by using an automatic generation tool 62c for Java Applet, which is a client software of Java downloaded and executed in a browser, a client application 63c for Java Applet is generated.

Moreover, by using an automatic generation tool 62d for Visual Basic, which is programming language based on Basic for facilitating the generation of graphic user interface, a client application 63c for Visual Basic is generated.

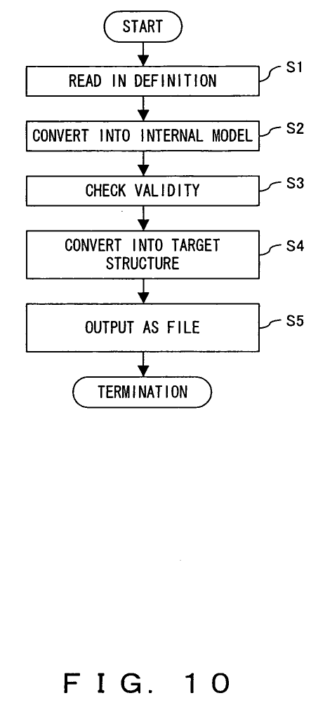

FIG. 10 is a basic flow chart of the user interface application program generation process using the automatic generation tools. When the process is started in FIG. 10, in step S1, first, text format definition (body), for example, is loaded, the definition body is converted to an internal model of UML, for example, or object model of Java language, for example, in step S2, and a validity check of whether the model is valid or not is carried out in step S3. Up until the step S3 the processes are of platform-independent.

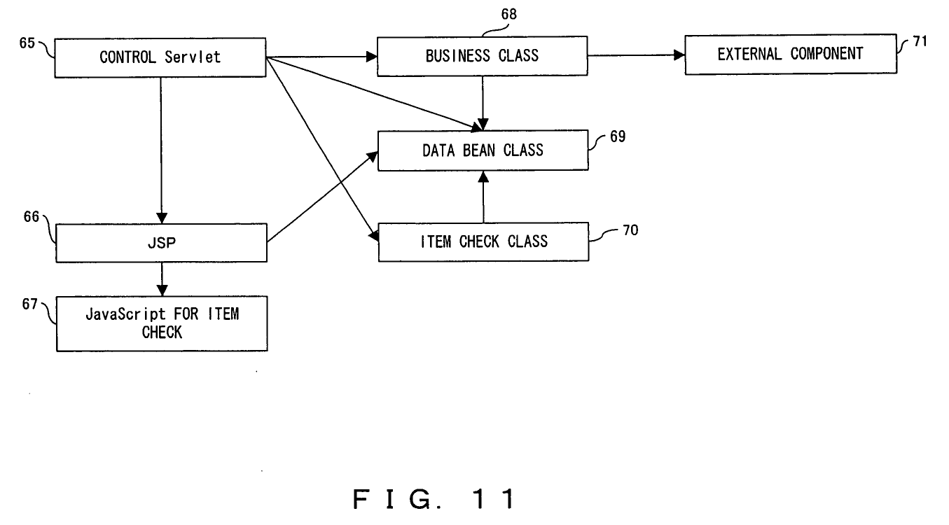

Subsequently, in step S4, the inner model structure is converted to a structure dependent to a target, or platform, such as a structure explained later in FIG. 11, for example, each file as programs is output in step S5, and the process is terminated.

Such program generation using the automatic generation tools, or operation of the automatic generation tools for JSP/Servlet in definition body conversion, is further stated below. Each definition body is converted in accordance with the following rules. The screen layout definition is originally dependent on the platform and described by JSP.

As for screen transition definition, one screen transition definition is converted to one business class. Screen activity corresponds to screen display by JSP, process activity is converted into a call for the corresponding business class method, and screen transition activity is to be a call for the other screen transition. As to parameters, the screen activity parameter corresponds to input display data on the screen, and is converted to a Data Bean object, which is to be an input to JSP.

Business class, as well, corresponds to input/output data and is converted to the Data Bean class. Transition between activities is converted to regulations of display screen and process order, and for the flow between parameter, data association is generated.

As for the screen item definition, the item definition itself is converted to Data Bean class, and as for the screen item constraint definition, a check site is converted into JavaScript, which is a script language of the Web client side or item check class, by assignment of client side or server side.

With regard to business flow, it is converted into one of the methods in business class. For logic activity, a call code of designated external component is generated in a method of business class, and for business flow activity, a call code is generated as well. Parameters are set as activity data, the order is generated for transition between activities, and, for the flow between parameters, data association is generated.

With regard to the intermediate data definition, it is converted into Java Bean class.

FIG. 11 is a structure to explain operation of the application generated automatically in the way described above, and is equivalent to a MVC model comprising model, view, and controller.

In FIG. 11, when a request is provided to a control servlet 65 for controlling the whole, for example, from exterior, data is set in Data Bean class (equivalent to data folder), and a business class 68 is operated. Business class 68 carries out process by calling up the external component 71, reads/writes data of Data Bean class 69 during the preceding process, and writes data of the process result.

Then control is moved to JSP 66. The JSP 66 is for screen display, and it displays while reading data of the Data Bean class 69. In so doing, when there are constraints in screen display items, JavaScript for item check 67 runs in the browser side and detects constraint item faults as errors. When data is given to Data Bean class 69 from the control Servlet 65 side at first, the constraint items can be checked by an item check class 70.

The following description is further details of such operations.
1. Transmission button is pressed in browser
2. JavaScript for item check 67 checks data content. If content has error and there is “Retry Error” transition, an error message is displayed without transmission
3. A request is sent from the browser to the control Server 65
4. Data is set at the Data Bean class 69, and the item check class 70 checks the content. If the content has error and there is “Retry Error” transition, the original screen is re-displayed indicating error.
5. The business class 68 supporting the current business flow is called up.
6. The external component 71 is called according to the business flow definition
7. The control moves to JSP 66 in accordance with screen transition definition
8. The JSP 66 acquires data from the Data Bean class 60 and displays it.

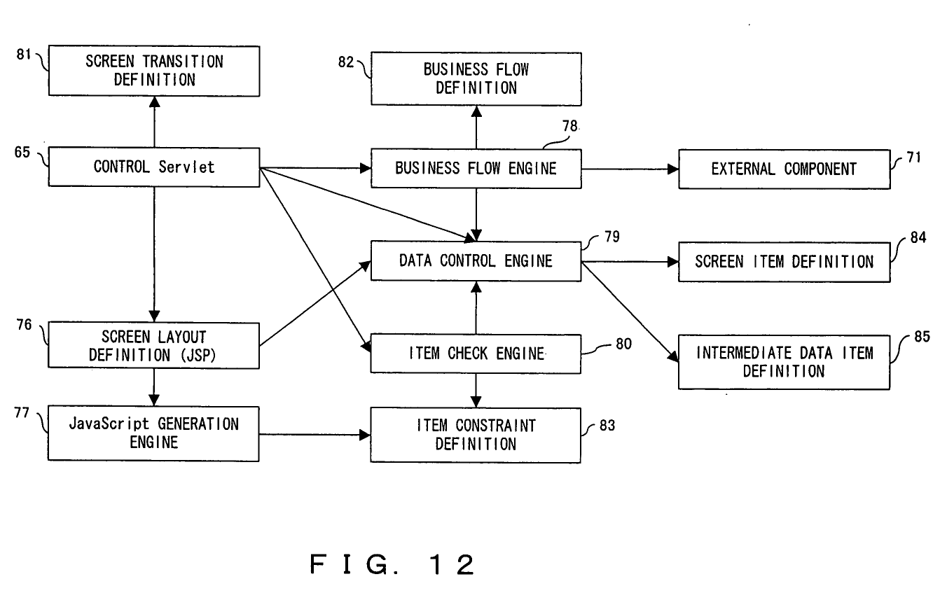

In the present embodiment, as explained in FIG. 9, it is possible to carry out an actual process as an application by reading in a platform-independent definition body using a platform-dependent automatic generation tools and by interpreting the definition body 61 itself instead of automatically creating a user interface program. FIG. 12 explains operation form in such case. In FIG. 12, the screen layout definition 76, the screen transition definition 81, the business flow definition 82, the item constraint definition 83, the screen item definition 84 and the intermediate data item definition 85 are provided, and a JavaScript generation engine 77 instead of the JavaScript for item check 67 in FIG. 11, a business flow engine 78 instead of the business class 68, a data control engine 79 instead of the Data Bean class 69 and an item check engine 80 instead of the item check class 70 are comprised, and operations equivalent to compiler and interpreter are performed.

Next, in the present embodiment, screen layout can be automatically generated from the screen item definition. There are types for the screen item definition such as the character string, integer numbers, real numbers, date, enumeration, and combined type, as explained in FIG. 2, and by corresponding these types to display parts in the screen layout, automatic generation is made possible. When the other types are defined, it is possible to handle the type by establishing rules of screen layout generation for each type.

In the present embodiment, in the case that the type is a character string, an integer number, a real number or a date, by relating to text field in screen layout, enumeration to radio buttons and by relating combined type to tables, automatic generation of screen layout is possible.

The following description is an explanation of generation of an external specification. In the present invention, the external specification document is generated by using specification generation tool from definition body, which has defined specification. In general, an internal specification for carrying out applications and an external specification for providing to customers have the following differences.

The external specification requires a specification required from customers and atypical additional information such as author for the external specification. The information can be added by using a column for filling comments prepared in the definition body.

For external specification, not all information of definition body equivalent to internal specification is necessarily needed, and the information can be filtered by the specification generation tool. However, the external specification requires customer-specific layout information, and using external specification layout definition, such information can be added. With atypical additional information made as model expansion information, the external specification document and the internal specification document can be combined as one piece of model information and can be stored in a storage device of a computer, which works as a user interface application development device.

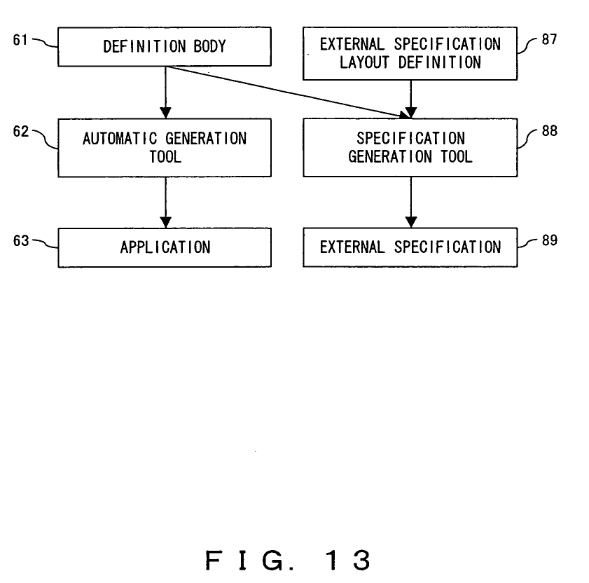

FIG. 13 is an explanatory diagram of automatic generation of application by an automatic generation tool and generation of the external specification document by the specification generation tool. The external specification 89 can be automatically generated from the external specification layout definition 87 by the specification generation tool 88 at the same time as the application 63 is automatically generated from the definition body 61 by the automatic generation tool 62 explained in FIG. 9.

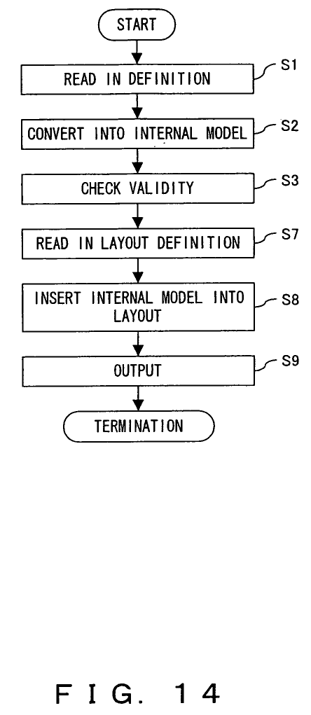

FIG. 14 is a basic flowchart of the external specification generation process. In step S1 and S2 in FIG. 14 first, reading of definition and conversion to internal model are carried out as they are in FIG. 10. And a validity check in step S3 follows, and the platform-independent process is to be finished at this step.

In step S7, reading of the external specification layout definition 87 is carried out, and the internal model is embedded in the layout in step S8. For example, if the display area of diagrams and that of tables are determined as screen layout, the screen transition diagram is inserted in the display area of diagrams and the class information is inserted in the display area of tables. Then the external specification 89 generated in step S9 is output and the process is terminated.

In the present embodiment, in order to allow detection of execution place of instructions during execution of a program or during debug, an instruction to issue events indicating execution place by definition is embedded every time the execution place by definition changes. By so doing, it is possible to detect instruction execution place and data value added to an event during program execution or during debug.

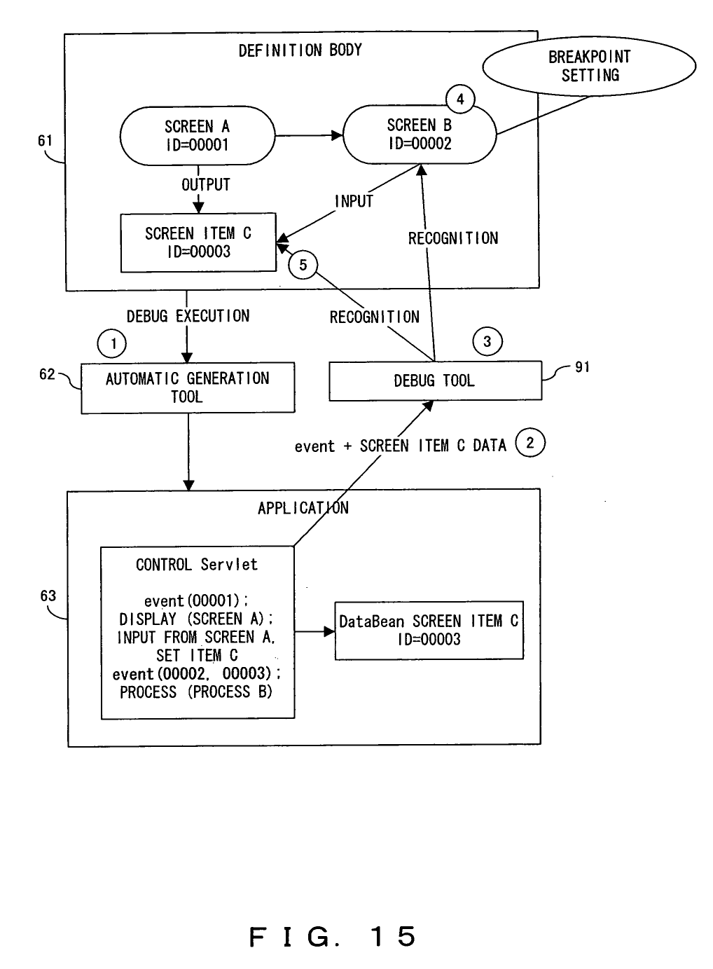

FIG. 15 is an explanatory diagram of an example of the execution place detection and breakpoint setting. In FIG. 15, when execution of debug is designated by the definition body 61 side, the application 63 is generated in (1) using the automatic generation tool. In so doing, when identifiers are assigned to each of by-definition activity and data item and the activities are executed by generated code, a code, for transmitting the assigned identifiers as an event, is embedded.

In execution of an activity by the application 63 in (2), an event is issued. When a screen item C is designated in the event, value of the screen item C is attached to the event as shown in FIG. 15, and is provided to a debug tool 91.

The debug tool 91 receives the event in (3), and is able to recognize an activity in definition body, which is relevant to the received identifier.

The execution continues in normal process however, when a breakpoint, corresponding to a process B identified by the identifier as indicated in (4), is set, execution of application is stopped once, and the relevant activity is displayed in highlight.

In addition, the debug tool 91 can recognize screen items. As indicated by (5), because data value is also attached to the screen item C, data value input from the process B side can be displayed.

In the following description, execution of test in the present embodiment is explained. Using a test data generation tool, test data is created based on the screen item definition and the screen item constraint definition, and by automatically inputting the data when the screen is displayed, the test can be executed automatically.

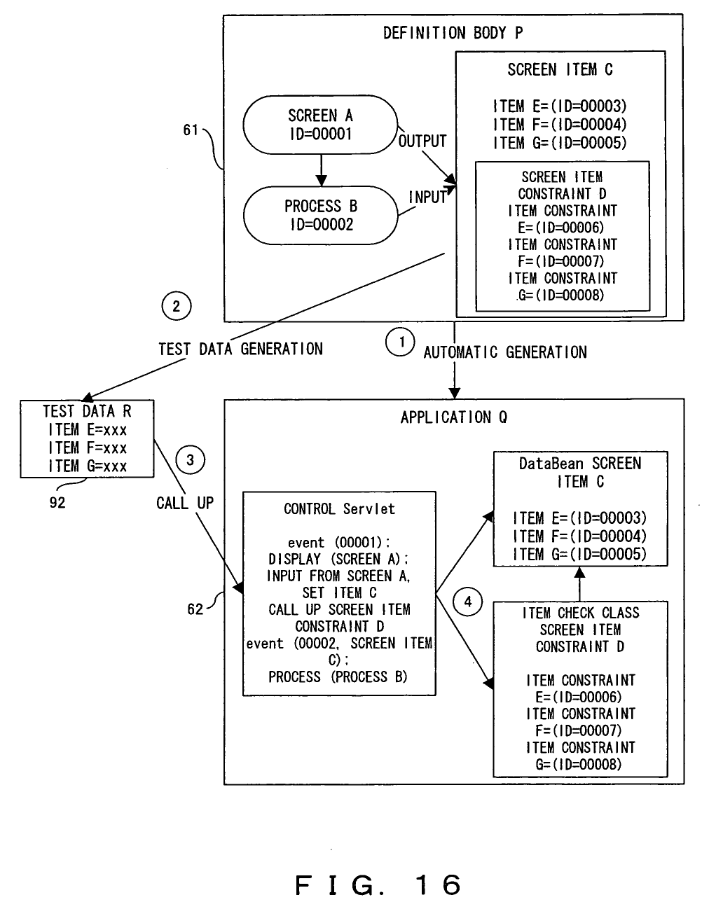

FIG. 16 is an explanatory diagram of the test execution method. In FIG. 16, an application Q63 is automatically generated by an automatic generation tool 62 in (1) from a definition body P61.

Test data R92 is created from the screen item C and screen item constraint D by the test data generation tool in (2) corresponding to the definition body P61. The screen item C represents output (input by a user) from a screen A and input to the process B, and is comprised of item E, F and G. Constraints are set for each item, and the constraints are defined by the screen item constraint D.

In execution of an application Q62, the test data R92 calls up the control Servlet in the application Q62.

The control servlet receives data from the screen (test data R) following the definition of definition body, calls up the item check class in (4), and determines whether or not the contents of the items E, F and G meet the constraints.

The test data is created according to the predetermined rule. The rule is determined for each type. When defining a type, which the rule is not determined for, by determining the rule along with type definition, test data of the type can be generated. As to the following types, change or addition to rules can be made as needed.

For character strings, test data such as blank strings, character number with (minimum digit number−1) digit, character strings with (minimum digit number) digit, and character strings with (minimum digit number+1) digit in response to constraints of the minimum digit number limit. The first two are to be test data violating the constraints, when such test data are used, errors have to be detected.

As for constraints of maximum digit limit, test data such as blank strings, character strings with (maximum digit number−1) digit, character strings with (maximum digit number) digit, and character strings with (maximum digit number+1) digit are generated. For character type limit constraint, test data of character string meeting constraint, and that of character string not meeting constraints are generated. As to constraints of compulsory input, test data of blank character strings and that of not blank character strings are generated.

To the types of the integer number and real number, the test data of (minimum value−1), (minimum value), and (minimum value+l) in response to the minimum value limit, and test data of (maximum value−1), (maximum value), and (maximum value+1) in response to the maximum value limit are used. For constraints of compulsory input, test data of blank input, that is the state with no data input, and arbitrary value are used.

As to date type, for the constraint of whether the date exists or not, test data of the existing date, date which does not exist (e.g. Feb. 29, 2003), date, which exists only in leap year (e.g. Feb. 29, 2004) are created, and for constraint of compulsory input, test data of blank input or the existing date is also created. As to the type of enumeration, test data of unselected, or the test data in which selection has not been carried out, single selection, double selection and all selection are generated for constraints of single selection limit, and test data of unselected, single selection, double selection and all selection are generated for constraints of compulsory input.

For the test data of combined type, test data adopting each constraint contents of the included item is created.

In the following description, detection of affected range when in modification of specification data etc. occurs is explained. Using test data, affected range after definition body modification can be detected. That is, in the system in FIG. 16 explaining test data generation and test execution, when a test is executed using the same test data after modifying the definition body by storing execution place and data of the instruction at the timing of event issue, the affected range after definition body modification can be detected from a comparison of execution place of the instruction and data in the same event issue timing with the stored value.

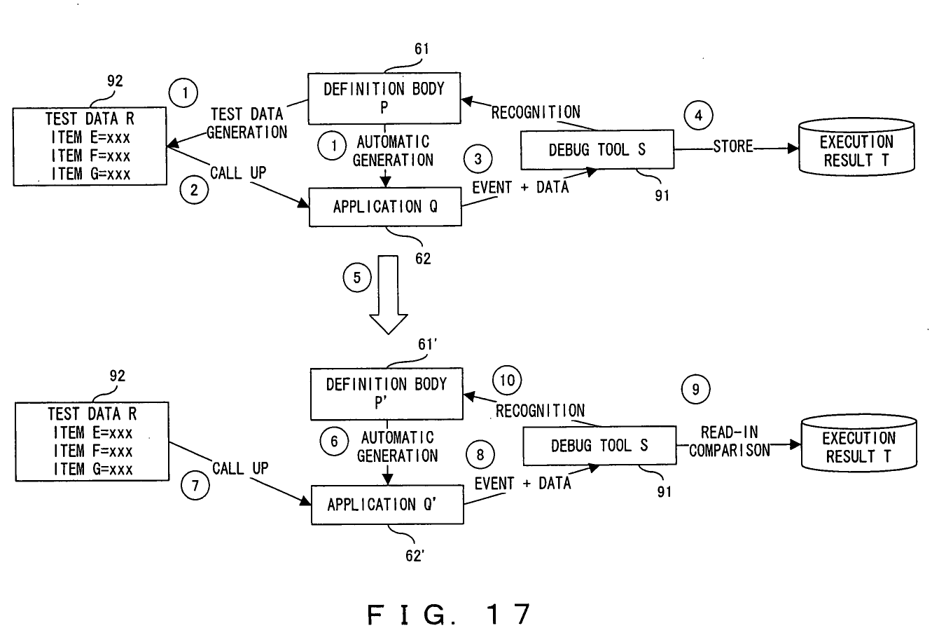

FIG. 17 is an explanatory diagram of such affected range detection operation after definition body modification. In FIG. 17, automatic generation of the application Q62 and generation of test data R92 from the definition body P61 are carried out in (1), the test data R92 is called up in (2), and the application Q62 is operated. In (3), execution place and data of the instruction are provided to the debug tool S91 at the timing of event issue, and the place and data are stored as execution result T in (4).

The definition body P is modified in (5), and a definition body P40 61′ is acquired. An application Q′ 62′ is generated from the modified definition body in (6). In (7) and (8), the test data R92 is called up, and execution place and data of the instruction are provided to the debug tool S91 at the timing of event issue in the same way as before modification. By comparing them with the previous execution result T, if data is different, the execution place and data content of the instruction at that time are displayed in (10) as location of the definition body P′ 61′.

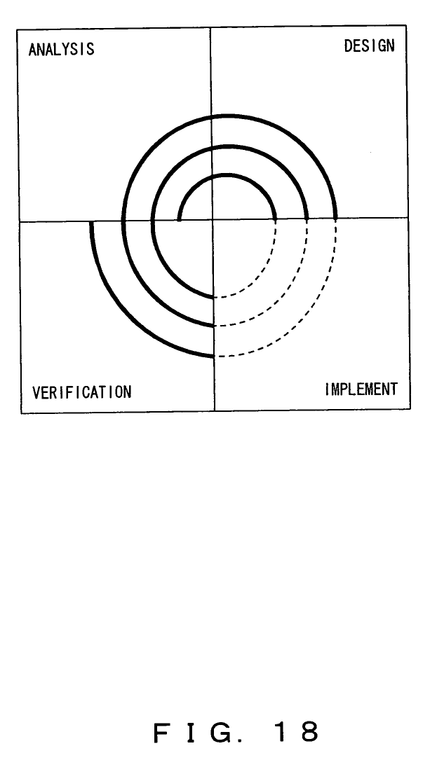

In the following description, development process of a user interface application in the present embodiment is explained using FIG. 18. In the present embodiment, user interface application can be developed step by step by recursively repeating phases of analysis, design, implement, and verification starting from a minimum of screen transition definition as explained in FIG. 7.

In the analysis phase, first, an analysis of how the definition body should be described is conducted from customer's request item, for example. In the design phase, the definition body is generated based on the analysis result acquired in the analysis phase, and in the implement phase, application and test data are created from the definition body. And in the verification phase, lastly, the test data is input to the generated application, and the application is tested. Because the result of the test can be indicated as location of the definition body, the process returns to the analysis phase examining that, if modification is required, which part of the definition body should be modified.

In FIG. 18, a solid line, rotating clockwise, indicates that the analysis phase starts from innermost as the minimum definition state, or the smallest state, explained in FIG. 7. By repeating each phase, the size etc. of the definition body becomes large, and when it is determined that modification is not required in the last verification phase, development is terminated. Here, the reason of thin line in the implement phase indicates that, in the present embodiment, it is not necessarily required to actually develop program codes using the automatic generation tool, that is as explained in FIG. 12, by reading in various types of definitions, interpreting them and executing, generation of the program code itself is not necessarily required.

As explained in detail, according to the present invention, with format alternately describing a screen and process, a program development specification data, which is equivalent to a screen transition diagram corresponding to a user interface application, can be created, and using the data, automatic generation of a user interface application can be achieved. It facilitates development and maintenance of the user interface application and debug when defining specification data etc. can be supported. Also, recursive development, which repeats phases of analysis, design, implement, and verification, is made possible, and thus, the present invention greatly contributes to improvement of efficiency and maintainability of program development.

The present invention can be used in the software development industry where user interface application programs such as Web applications are developed and where those programs are provided to business vendors dealing with users.

1. A user interface application development device comprising:
specification data reading means for reading in specification data for program development, the specification data being equivalent to a screen transition diagram with a format alternately describing a screen and process, in which a screen is related to a display input data item and has a display input data item is related to a screen layout; and
program generation means for automatically creating a user interface application program using the specification data.

2. A user interface application development device comprising:
specification data reading means for reading in specification data for program development, the specification data being equivalent to a screen transition diagram with a format alternately describing a screen and process, in which a screen is related to a display input data item and a display input data item is related to a screen layout; and
process execution means for executing user interface application processes, interpreting the specification data and in response to the interpretation result.

3. A user interface application development device, comprising:
specification data reading means for reading in a specification data for program development, the specification data being equivalent to a screen transition diagram with format describing transition between a plurality of screens to which corresponding processes are to be determined, in which a screen is related to a display input data item and a display input data item is related to a screen layout; and
program generation means for automatically creating user interface application program using the specification data,
wherein the user interface application development device repeats the operations of the specification data reading means and the program generation means while the corresponding processes and two associating contents are modified.

4. The user interface application development device according to claim 1, further comprises constraint condition check means for checking constraint conditions established in response to the display input data items, and when the conditions are not met, prohibiting transition from a screen to process on the screen transition diagram.

5. The user interface application development device according to claim 4, wherein information to designate checkpoints of the constraint conditions in response to the constraint conditions is provided and the constraint condition check means checks in response to the designation.

6. The user interface application development device according to claim 1, further comprises application verification means for creating test data by corresponding the display input data items and the constraint conditions relating to the display input data items, and for verifying a program by inputting the test data to the generated program.

7. The user interface application development device according to claim 6, wherein the application verification means stores verification result of the program, and, when the specification data for program development is modified, detects the affected range of specification data modification using the same test data by comparing the verification result with the modified verification result.

8. The user interface application development device according to claim 1, further comprises screen generation means for carrying out automatic screen generation, following rules relating to predetermined screen layout in response to the display input data items.

9. The user interface application development device according to claim 1, further comprises external specification generation means for filtering internal specification information which is equivalent to the specification date for program development and represents the user interface application model, following predetermined definition, and for automatically creating an external specification document combining atypical additional information representing the external specification.

10. The user interface application development device according to claim 9, further comprises storage means for storing the additional information made as model expansion information, being the combination of the external specification document and the internal specification document as one piece of model information.

11. The user interface application development device according to claim 1, further comprising debug means for debugging a program generated by the program generation means, wherein the program generation means, in automatic generation of the program, embeds instructions for event issue in the program, and the debug means receives the event during debugging and recognizes the embedded place of event issue instruction as the execution place of a program.

12. The user interface application development device according to claim 11, wherein the program generation means sets information indicating breakpoints as a process in response to the event issue, and the debug means, when detecting the information, emphasizes the part corresponding to the breakpoint on the screen.

13. The user interface application development device according to claim 11, wherein the program generation means embeds data used in the embedded place of the event issue instruction in the event, relating the data with classes on the diagram representing the specification data by identifiers, and the debug means detects the data type and value in receiving the event.

14. The user interface application development device according to claim 13, wherein the debug means stores the detected data value and detects affected range of an application modification by comparing the detected data value with the data at the same location after application modification when debugging.

15. A user interface application development method comprising steps of:
reading in a specification data for program development, the specification data being equivalent to a screen transition diagram with a format alternately describing a screen and process, in which a screen is related to a display input data item and a display input data item is related to a screen layout; and
automatically creating a user interface application program using the specification data.

16. A program causing a computer, which develops a user interface application, to execute procedures of:
reading in specification data for program development, equivalent to a screen transition diagram with a format alternately describing a screen and process, in which a screen is related to a display input data item and a display input data item is related to a screen layout; and
automatically creating a user interface application program using the specification data.
